(19) United States
(12) Patent Application Publication
(10) Pub. No.: US 2024/0053521 A1
(43) Pub. Date: Feb. 15, 2024

(54) OMNIDIRECTIONAL STRUCTURAL COLOR MICROSTRUCTURES COMPRISING TITANIUM DIOXIDE

(71) Applicant: Toyota Motor Engineering & Manufacturing North America, Inc., Plano, TX (US)

(72) Inventors: Debasish Banerjee, Ann Arbor, MI (US); Songtao Wu, Ann Arbor, MI (US); Hidetaka Asano, Aichi-ken (JP)

(73) Assignees: Toyota Motor Engineering & Manufacturing North America, Inc., Plano, TX (US); Toyota Jidosha Kabushiki Kaisha, Aichi-ken (JP)

(21) Appl. No.: 17/886,768

(22) Filed: Aug. 12, 2022

(51) Int. Cl. G02B 5/28

(52) U.S. Cl. CPC G02B 5/285

(57) ABSTRACT

A multilayer thin film that reflects an omnidirectional structural color having a reflective core layer; an amorphous-phase TiO₂ dielectric layer extending across the reflective core layer; a metallic absorbing layer extending across the dielectric layer; and a dielectric outer layer extending across the metallic absorbing layer. The multilayer thin film reflects a single narrow band of visible light when exposed to broadband electromagnetic radiation, and a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

### FIELD

The present application is related to multilayer thin film structures, and in particular to multilayer thin film structures comprising Titanium Dioxide that exhibit a minimum or non-noticeable color shift when exposed to broadband electromagnetic radiation and viewed from different angles.

### BACKGROUND

Pigments made from multilayer structures are known. In addition, pigments that exhibit or provide a high-chroma omnidirectional structural color are also known. However, forming multilayer structures out of certain materials can be difficult because the deposition techniques for depositing various materials can have a negative impact on previously deposited materials. In addition, certain deposition techniques can be costly and time consuming making it very difficult to achieve a commercially viable multilayer structures.

It is appreciated that the color produced by multilayer thin film structures is dependent on the materials used as the various layers, the location of materials within the multilayer thin film structure, and the properties of the individual layers (e.g., thickness). Accordingly, small variations in multilayer thin film structure design can have a distinct impact on the color produced by the multilayer thin film structure. However, conventional deposition techniques are not always effective for depositing the desired layers within a multilayer thin film structure to achieve the best combinations for omnidirectional multilayer thin films.

### SUMMARY

According to embodiments, a multilayer thin film that reflects an omnidirectional structural color comprises: a reflective core layer; an amorphous-phase TiO₂ dielectric layer extending across the reflective core layer; a metallic absorbing layer extending across the amorphous-phase TiO₂ dielectric layer; and a dielectric outer layer extending across the metallic absorbing layer, wherein the multilayer thin film reflects a single narrow band of visible light when exposed to broadband electromagnetic radiation, the single narrow band of visible light comprising: a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

In some embodiments, a multilayer thin film that reflects an omnidirectional structural color comprises: a reflective core layer; a protective layer encapsulating the reflective core layer; an amorphous-phase TiO₂ dielectric layer extending across at least a portion of the protective layer; a metallic absorbing layer extending across the amorphous-phase TiO₂ dielectric layer; and a dielectric outer layer extending across the metallic absorbing layer, wherein the multilayer thin film reflects a single narrow band of visible light when exposed to broadband electromagnetic radiation, the single narrow band of visible light comprising: a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

In some embodiments, a multilayer thin film that reflects an omnidirectional structural color comprises: a reflective core layer; a protective layer encapsulating the reflective core layer; an amorphous-phase TiO₂ dielectric layer extending across at least a portion of the protective layer; a barrier layer extending across the amorphous-phase TiO₂ layer, a metallic absorbing layer extending across the barrier layer; and a dielectric outer layer extending across the metallic absorbing layer, wherein the multilayer thin film reflects a single narrow band of visible light when exposed to broadband electromagnetic radiation, the single narrow band of visible light comprising: a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

In some embodiments, a multilayer thin film that reflects an omnidirectional structural color comprises: a reflective core layer; an amorphous-phase TiO₂ dielectric layer extending across at least a portion of the reflective core layer; a barrier layer extending across the amorphous-phase TiO₂ dielectric layer; a metallic absorbing layer extending across the barrier layer; and a dielectric outer layer extending across the metallic absorbing layer, wherein the multilayer thin film reflects a single narrow band of visible light when exposed to broadband electromagnetic radiation, the single narrow band of visible light comprising: a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

According to other embodiments, a method for forming the multilayer thin film comprises: depositing an amorphous-phase TiO₂ dielectric layer onto the reflective core layer by CVD or ALD; depositing a metallic absorbing layer onto the amorphous-phase TiO₂ dielectric layer by ALD; and depositing a dielectric outer layer onto the metallic absorbing layer by CVD or ALD.

In some embodiments, a method for forming the multilayer thin film comprises: depositing a protective layer onto a reflective core layer by wet chemical processes; depositing an amorphous-phase TiO₂ dielectric layer onto the protective layer by CVD or ALD; depositing a metallic absorbing layer onto the amorphous-phase TiO₂ dielectric layer by ALD; and depositing a dielectric outer layer onto the metallic absorbing layer by CVD or ALD.

In some embodiments, a method for forming the multilayer thin film comprises: depositing a protective layer onto a reflective core layer by wet chemical processes; depositing an amorphous-phase TiO₂ dielectric layer onto the protective layer by CVD or ALD; depositing a barrier layer onto the amorphous-phase TiO₂ dielectric layer; depositing a metallic absorbing layer onto the barrier layer by ALD; and depositing a dielectric outer layer onto the metallic absorbing layer by CVD or ALD.

According to other embodiments, a method for forming the multilayer thin film comprises: depositing an amorphous-phase TiO₂ dielectric layer onto the reflective core layer by CVD or ALD; depositing a barrier layer onto the amorphous-phase TiO₂ dielectric layer by ALD; depositing a metallic absorbing layer onto the barrier layer by ALD; and depositing a dielectric outer layer onto the metallic absorbing layer by CVD or ALD.

Additional features and advantages will be set forth in the detailed description that follows, and in part will be readily apparent to those skilled in the art from that description or recognized by practicing the embodiments described herein, including the detailed description that follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1A and FIG. 1B are schematic cross sections of a multilayer thin film structure according to embodiments disclosed and described herein;

FIG. 2A depicts a multilayer thin film with a dielectric layer extending over a reflective core layer used in the design of a multilayer thin film;

FIG. 2B depicts a multilayer thin film with a semiconductor absorbing layer extending over a reflective core layer used in the design of a multilayer thin film;

FIG. 2C depicts a multilayer thin film with a dielectric absorbing layer extending over a reflective core layer used in the design of multilayer thin films according to one or more embodiments shown and described herein;

FIG. 3 depicts reflectance properties of the multilayer thin films illustrated in FIGS. 2A-2C on a Lab color space;

FIG. 4A graphically depicts chroma and hue values as a function of dielectric layer thickness for the multilayer thin film illustrated in FIG. 2A;

FIG. 4B graphically depicts chroma and hue values as a function of semiconductor absorbing layer thickness for the multilayer thin film illustrated in FIG. 2B;

FIG. 4C graphically depicts chroma and hue values as a function of dielectric absorbing layer thickness for the multilayer thin film illustrated in FIG. 2C;

FIG. 5 is a magnified image of a rutile-phase TiO₂ dielectric layer deposited on a protective layer;

FIG. 6 is a magnified image of a rutile-phase TiO₂ dielectric layer deposited on a protective layer, a metallic absorbing layer deposited on the rutile-phase TiO₂ dielectric layer, and dielectric outer layer deposited on the metallic absorbing layer;

FIG. 7 is a magnified image of an amorphous-phase TiO₂ dielectric layer deposited on a protective layer, a metallic absorbing layer deposited on the amorphous-phase TiO₂ dielectric layer, and dielectric outer layer deposited on the metallic absorbing layer;

FIG. 8 depicts a multilayer thin film with a dielectric layer extending over a substrate layer and exposed to electromagnetic radiation at an angle θ relative to a normal direction to the outer surface of the dielectric layer;

FIG. 9A to 9E graphically depict reflection curves for examples provided herein; and

FIG. 10A to 10F graphically depict reflection curves for examples provided herein.

### DETAILED DESCRIPTION

A structure that produces omnidirectional structural color is provided in this disclosure. The structure that produces omnidirectional structural color has the form of a multilayer thin film (also referred to as a multilayer stack herein) that reflects a narrow band of electromagnetic radiation in the visible spectrum and has a small or non-noticeable hue shift when the multilayer thin film is viewed from angles between 0 to 45 degrees. The multilayer thin film can be used as pigment in composition (such as, for example, a paint composition), a continuous thin film on a structure, and the like.

Preparing omnidirectional structural color multilayer thin films can be a complex, expensive process because, in part, very tight control over layer thicknesses is required. The deposition methods used to deposit layers can vary in complexity and cost depending on the material that makes up a given layer and the desired thickness of the layer. Accordingly, different materials that makes up a given layer and the desired thickness of the layer. Accordingly, different materials that can be deposited by different deposition techniques are desired.

However, it can be challenging to deposit layers directly on a reflective core layer, such as an aluminum (Al) reflective core layer by less expensive wet chemical methods as these methods require highly acidic or basic conditions. In addition, there are challenges to depositing precisely-controlled ultrathin absorber layers other than by vacuum coating methods. In this disclosure, a combination of deposition methods are used to reduce cost and still achieve a desirable multilayer thin film structure. Using TiO₂ as a dielectric material allows one to use a combination of wet chemical methods, atomic layer deposition (ALD), such as fluidized bed ALD, and chemical vapor deposition (CVD), such as fluidized bed CVD. For instance, ALD can precisely deposit thin layers, but ALD is costly and time-consuming. CVD is less costly and less time-consuming than ALD, but is not as precise as ALD and is not well suited for depositing very thin layers. Wet chemical methods are relatively quick and inexpensive, but they are not as good for depositing very thin layers and have the issues discussed above using acidic or basic conditions. Therefore, a combination of ALD, CVD, and wet chemical methods can be used in embodiments with TiO₂ dielectric materials to form multilayer thin films at lower costs and higher efficiency than just using ALD.

The multilayer thin film structures described herein may be used to omnidirectionally reflect wavelengths of visible light over a range of angles of incidence or viewing (such as hues between 0° and 120°). It will be understood that the terms “electromagnetic wave,” “electromagnetic radiation,” and “light,” as used herein, may interchangeably refer to various wavelengths of light incidence on a multilayer thin film structure and that such light may have wavelengths in the ultraviolet (UV), infrared (IR), and visible portions of the electromagnetic spectrum.

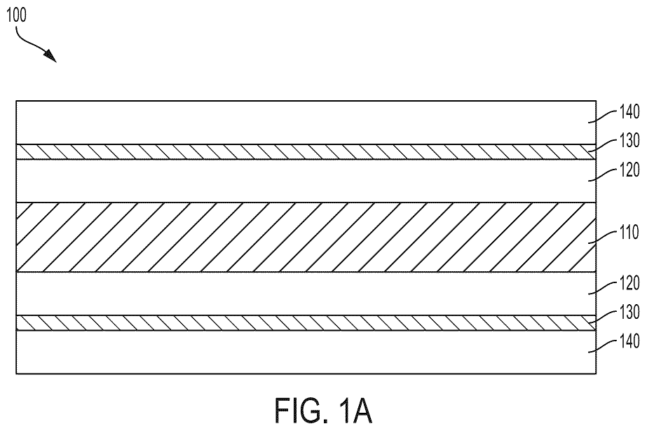

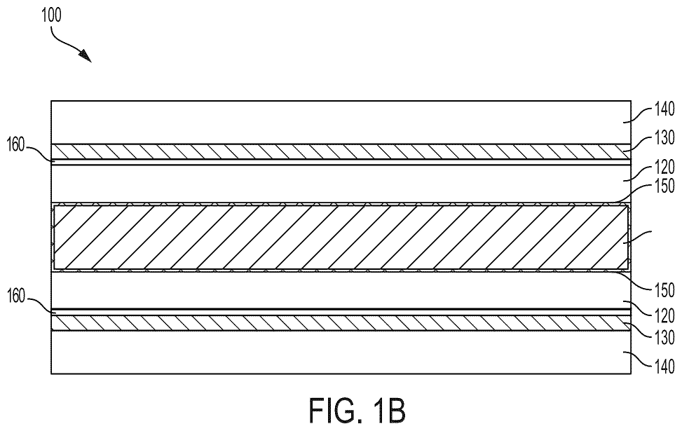

Referring now to FIG. 1A, a multilayer thin film 100 according to embodiments disclosed and described herein comprises a reflective core layer 110, at least one dielectric layer 120 that extends across the reflective core layer 110, at least one metallic absorbing layer 130 that extends across the at least one dielectric layer 120, and at least one dielectric outer layer 140 that extends across the at least one metallic absorbing layer 130.

In some embodiments, and with reference to FIG. 1B, the multilayer thin film 100 comprises a reflective core layer 110, a protective layer 150 that encapsulates the reflective core layer 110, at least one dielectric layer 120 that extends across at least a portion of the protective layer 150, at least one barrier layer 160 that extends across the dielectric layer 120, at least one metallic absorbing layer 130 that extends across the at least one barrier layer 160, and at least one dielectric outer layer 140 that extends across the at least one metallic absorbing layer 130.

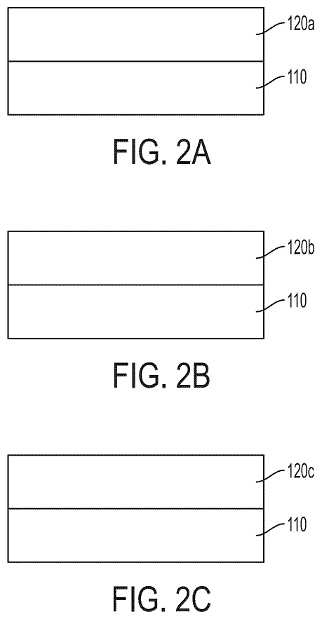

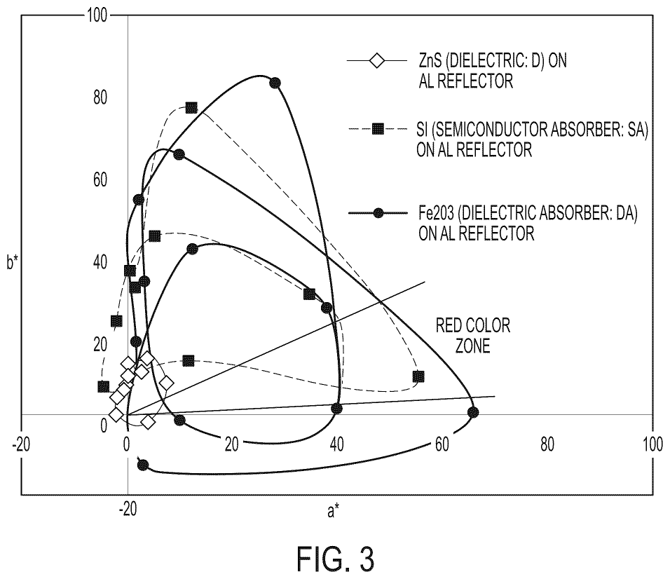

Referring to FIGS. 2A-2C and 3, the effectiveness of different types of layers extending across a reflective core layer 110 in attaining a desired hue level in a red region of the visible light spectrum as plotted or shown on a Lab color space is depicted. FIG. 2A depicts a ZnS dielectric layer 120a extending across a reflective core layer 110, FIG. 2B depicts a Si semiconductor absorbing layer 120b extending across a reflective core layer 110, and FIG. 2C depicts an Fe₂O₃ dielectric absorbing layer 120c extending across a reflective core layer 110. Simulations of the reflectance from each multilayer thin film illustrated in FIGS. 2A-2C are performed as a function of different thicknesses for the dielectric layer 120a, the semiconductor absorbing layer 120b, and dielectric absorbing layer 120c. The results of the simulations are plotted on a Lab color space, also known as an a*b* color map, shown in FIG. 3. Each data point shown in FIG. 3 provides a chroma and a hue for particular thickness of the dielectric layer for the multilayer thin film depicted in FIG. 2A, the semiconductor absorbing layer for the multilayer thin film depicted in FIG. 2B or the dielectric absorbing layer for the multilayer thin film depicted in FIG. 2C. Chroma can be defined as C=\sqrt{(a*²+b*²)} and hue can be defined as tan⁻¹(a*/b*). The hue can also be referred to as the angle relative to the positive a*-axis of a given data point. A hue value provides a measure of the color displayed by an object (e.g., red, green, blue, yellow etc.), and a chroma value provides a measure of the color's “brightness.” As shown in FIG. 3, the multilayer thin film illustrated in FIG. 2A provides low chroma compared to the multilayer thin films illustrated in FIGS. 2B and 2C. Accordingly, FIGS. 2A-2C and FIG. 3 demonstrate that an absorbing layer, (e.g., a dielectric absorbing layer) is preferred over a dielectric layer as a first layer extending over a reflective core layer when colors with high chroma are desired.

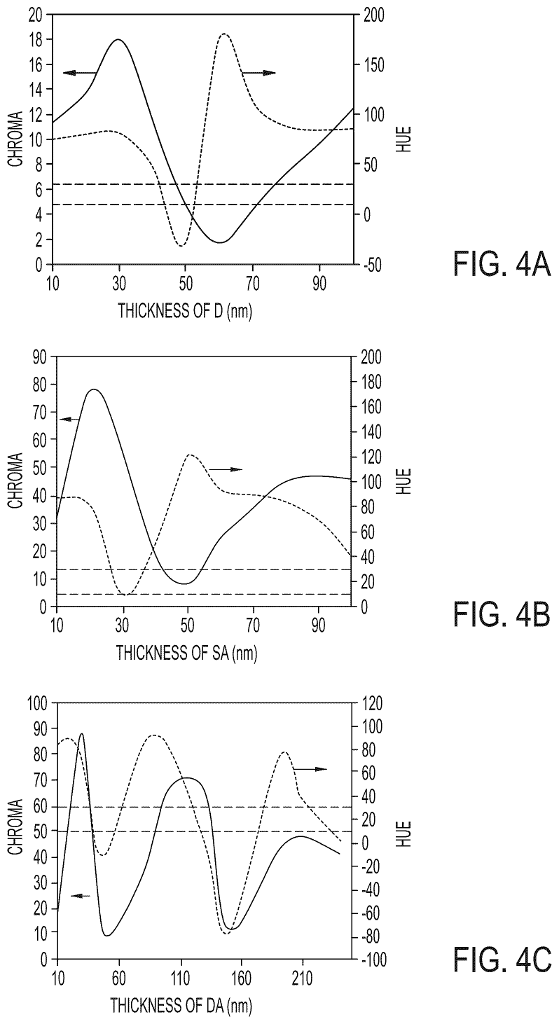

Referring to FIGS. 4A-4C, chroma and hue as a function of layer thickness is depicted. Specifically, FIG. 4A graphically depicts the chroma and hue as a function of the thickness of the ZnS dielectric layer extending over the Al reflective core layer illustrated in FIG. 2A. FIG. 4B depicts the chroma and hue as a function of the thickness of the Si semiconductor absorbing layer extending over the Al reflective core layer illustrated in FIG. 2B. FIG. 4C depicts the chroma and hue as a function of the thickness of the Fe₂O₃ dielectric absorbing layer extending over the Al reflective core layer illustrated in FIG. 2C. The dotted lines in FIGS. 4A-4C correspond to desired hue values between 10° and 30° on the Lab color space. FIGS. 4A-4C illustrate that higher chroma values within the hue range between 10° and 30° are achieved for multilayer thin films having a dielectric absorbing layer extending across the reflective core layer.

Referring again to FIG. 1A, a multilayer thin film 100 that reflects an omnidirectional high chroma structural color according to embodiments is shown. The multilayer thin film 100 includes a reflective core layer 110, a dielectric absorbing layer 120 extending across the reflective core layer 110, a metallic absorbing layer 130 extending across the dielectric absorbing layer 120, and a dielectric outer layer 140 extending across the at least one metallic absorbing layer 130. In embodiments, the “outer layer” has an outer free surface (i.e., an outer surface not in contact with an absorbing layer or another dielectric layer that is not part of a protective coating). It should be appreciated that in embodiments two dielectric absorbing layers 120, two metallic absorbing layers 130, and two dielectric outer layers 140 can be located on opposing sides of the reflective core layer 110 such that the reflective core layer 110 is a core layer sandwiched between a pair of dielectric absorbing layers 120, a pair of metallic absorbing layers 130, and a pair of dielectric outer layers 140. Such a multilayer thin film with a reflective core layer 110 sandwiched between a pair of dielectric absorbing layers 120, a pair of metallic absorbing layers 130, and a pair of outer dielectric layers can be referred to as a seven-layer multilayer thin film.

The reflective core layer 110 can, in embodiments, have a thickness between 50 nm and 500 nm, such as between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, between 450 nm and 500 nm, between 50 nm and 450 nm, such as between 100 nm and 450 nm, between 150 nm and 450 nm, between 200 nm and 450 nm, between 250 nm and 450 nm, between 300 nm and 450 nm, between 350 nm and 450 nm, between 400 nm and 450 nm, between 50 nm and 400 nm, such as between 100 nm and 400 nm, between 150 nm and 400 nm, between 200 nm and 400 nm, between 250 nm and 400 nm, between 300 nm and 400 nm, between 350 nm and 400 nm, between 50 nm and 350 nm, such as between 100 nm and 350 nm, between 150 nm and 350 nm, between 200 nm and 350 nm, between 250 nm and 350 nm, between 300 nm and 350 nm, between 50 nm and 300 nm, such as between 100 nm and 300 nm, between 150 nm and 300 nm, between 200 nm and 300 nm, between 250 nm and 300 nm, between 50 nm and 250 nm, such as between 100 nm and 250 nm, between 150 nm and 250 nm, between 200 nm and 250 nm, between 50 nm and 200 nm, such as between 100 nm and 200 nm, between 150 nm and 200 nm, between 50 nm and 150 nm, such as between 100 nm and 150 nm, or between 50 nm and 100 nm.

In embodiments, the reflective core layer 110 can be made from at least one of a “gray metallic” material, such as Al, Ag, Pt, Sn; at least one of a “colorful metallic” material, such as Au, Cu, brass, bronze, TiN, Cr, or a combination thereof.

The at least one dielectric absorbing layer 120 can, according to embodiments, have a thickness between 10 and 150 nm, such as between 25 nm and 150 nm, between 50 nm and 150 nm, between 75 nm and 150 nm, between 100 nm and 150 nm, between 125 nm and 150 nm, between 10 and 125 nm, between 25 nm and 125 nm, between 50 nm and 125 nm, between 75 nm and 125 nm, between 100 nm and 125 nm, between 10 and 100 nm, between 25 nm and 100 nm, between 50 nm and 100 nm, between 75 nm and 100 nm, between 10 and 75 nm, between 25 nm and 75 nm, between 50 nm and 75 nm, between 10 and 50 nm, between 25 nm and 50 nm, or between 10 and 25 nm.

The at least one dielectric layer 120 is TiO₂ and can be deposited across the reflective core layer 110 by CVD or atomic layer deposition ALD. It has unexpectedly been found that that certain phases of TiO₂ provide a dielectric layer 120 that allows uniform deposition of subsequent layers.

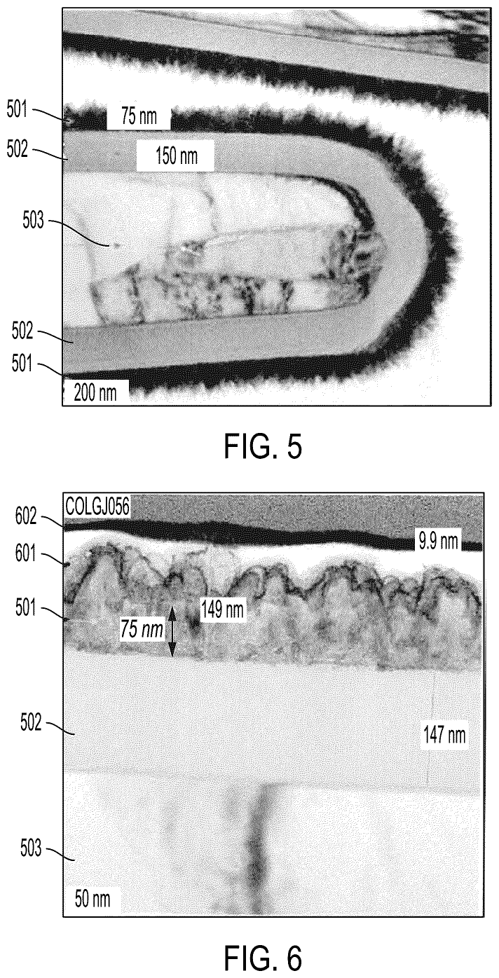

It has been found that crystalline-phase TiO₂, such as rutile-phase TiO₂ and anatase-phase TiO₂, is deposited to a substrate (such as the reflective core layer 110 or a protective layer, which is disclosed in more detail below) as an uneven, jagged layer. This uneven, jagged layer of crystalline-phase TiO₂ makes it difficult to deposit subsequent layers, and makes it extremely difficult to subsequently deposit uniform layers. Without being bound by any particular theory, it is believed that the crystalline structures of TiO₂ makes it difficult or even impossible to deposit a smooth layer of crystalline-phase TiO₂ at a nanoscale, which is required for multilayer thin film structures of embodiments. For instance FIG. 5 shows a magnified image of a rutile-phase TiO₂ dielectric layer 501 deposited onto a silica protective layer 502 that is positioned on a reflective core 503. In embodiments, the TiO₂ layer may be deposited by wet chemical processes. As can be seen in FIG. 5, the rutile-phase TiO₂ 501 has a very uneven, jagged surface when deposited at a nanoscale (about 200 nm). This results in a dielectric layer with a large surface area, and makes it very difficult and time consuming to deposit subsequent layer. Moreover, as shown in FIG. 6, a metallic absorbing layer 601 deposited on the rutile-phase TiO₂ dielectric layer 501 via ALD has an uneven thickness and surface that mimics the topography of the rutile-phase TiO₂ dielectric layer 501. It should be understood that the varying thickness and undulating surface of the metallic absorbing layer 601 could have significant effects on the electromagnetic radiation reflected from a multilayer thin film. In addition, the unevenness originated in the rutile-phase TiO₂ dielectric layer 501 propagates into undulations in the dielectric outer layer 602. Again, these undulations in the dielectric outer layer 602 can affect the electromagnetic radiation reflected by the multilayer thin film structure.

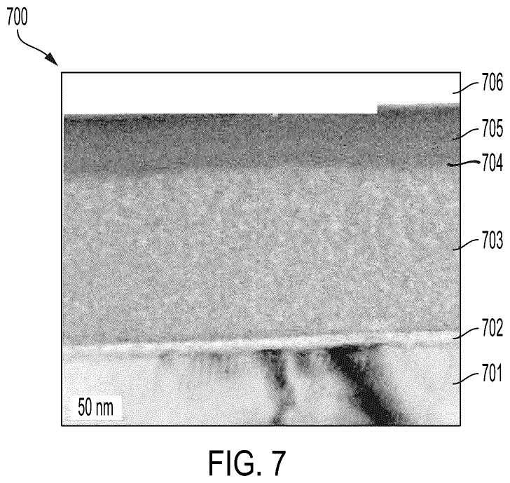

With reference now to FIG. 7, a multilayer thin film structure 700 made with an amorphous-phase TiO₂ dielectric layer will be described. In FIG. 7, a SiO₂ protective layer 702 is positioned over an Al reflective layer 701. Positioned over the protective layer is an amorphous-phase TiO₂ dielectric layer 703. Compared to the rutile-phase TiO₂ dielectric layer depicted in FIG. 5 and FIG. 6, the amorphous-phase TiO₂ dielectric layer 703 depicted in FIG. 7 has a smooth surface that allows subsequent layers to be deposited easily and uniformly (i.e., not have varying thicknesses and undulations). However, the amorphous-phase TiO₂ dielectric layer can, in embodiments, have a relatively high porosity, which can allow some material from the layer to be deposited onto the amorphous-phase TiO₂ to infiltrate into the amorphous-phase TiO₂ dielectric layer. When an optical layer, such as a metallic absorber layer, is deposited onto the amorphous-phase TiO₂ dielectric layer, this infiltration can alter the optical properties of the multilayer thin film structure. Accordingly, in embodiments—and as shown in FIG. 7—a barrier layer 704 that does not have significant optical properties may be deposited onto the amorphous-phase TiO₂ dielectric layer to fill in the pores before a metallic absorbing layer 705 is deposited onto the multilayer thin film structure. This barrier layer 704 is, in embodiments, made from alumina (Al₂O₃) and has a thickness that is less than or equal to 10 nm, such as less than or equal to 8 nm, less than or equal to 6 nm, less than or equal to 4 nm, or less than or equal to 2 nm and may be deposited onto the amorphous-phase TiO₂ dielectric layer by ALD. As shown in FIG. 7, an even and smooth tungsten metallic absorbing layer 705 is deposited on Al₂O₃ barrier layer 704, and an even and smooth TiO₂ dielectric outer layer 706 is deposited on the metallic absorbing layer 705. The multilayer thin film structure 700 depicted in FIG. 7 has layers with uniform thicknesses and minimal undulations, which provide even reflection of electromagnetic radiation.

To achieve an amorphous-phase TiO₂ dielectric layer, the ALD or CVD methods used to deposit the TiO₂ dielectric layer should be conducted at temperatures and pressures that do not allow the TiO₂ to crystallize and form a rutile or anatase phase. Without being bound by any particular theory, it is believed that the deposition temperature may aid in applying an amorphous-phase of TiO₂. For instance, in embodiments where the TiO₂ layer is deposited by CVD, the deposition temperature is below 500° C., such as below 475° C., below 450° C., below 425° C., or below 400° C. In embodiments where the TiO₂ layer is deposited by ALD, the deposition temperature is below 180° C., such as below 160° C., below 140° C., or below 120° C. Such application processes can provide a dense layer with little porosity. The surface of such layers is smooth as there is no rough, crystalline grain formation and little porosity.

A metallic absorbing layer 130 extends between the dielectric layer 120 and the dielectric outer layer 140. The location of the metallic absorbing layer 130 is chosen to increase the absorption of target light wavelengths. For instance, if the multilayer thin film is to be configured to absorb electromagnetic radiation having wavelengths that are less than or equal to 550 nm but reflect electromagnetic radiation with wavelengths of approximately 650 nm, such as visible light outside of the hue between 10° and 30°, the absorbing layer is placed at a thickness where the electric field (|E|²) is less at the 550 nm wavelength than at the 650 nm wavelength. Mathematically, this can be expressed as:

|E₅₅₀|²<<|E₆₅₀|² (1)

and preferably:

|E₆₅₀|²≈0 (2)

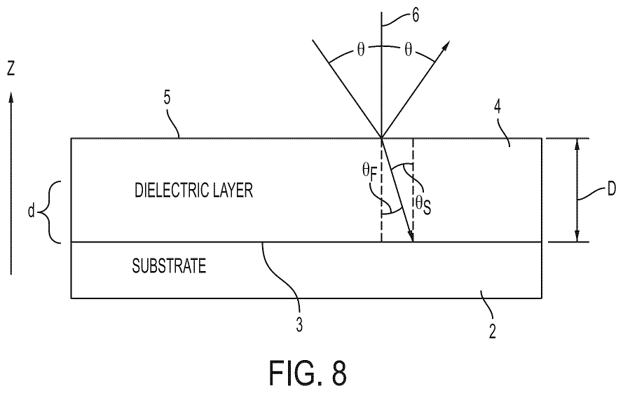

FIG. 8 and the following discussion provide a method for calculating the thickness of a zero or near-zero electric field point at a given wavelength of light, according to embodiments. For the purposes of the present specification, the term “near-zero” is defined |E|²≤10. FIG. 8 illustrates a multilayer thin film with a dielectric layer 4 having a total thickness “D”, an incremental thickness “d” and an index of refraction “n” on a substrate layer 2 having an index of refraction “nₛ”. The substrate layer 2 can be a core layer or a reflective core layer of a multilayer thin film. Incident light strikes the outer surface 5 of the dielectric layer 4 at angle θ relative to line 6, which is perpendicular to the outer surface 5, and reflects from the outer surface 5 at the same angle θ. Incident light is transmitted through the outer surface 5 and into the dielectric layer 4 at an angle θ_{F} relative to the line 6 and strikes the surface 3 of substrate layer 2 at an angle θₛ. For a single dielectric layer, θₛ=θ_{F} and the energy/electric field (E) can be expressed as E(z) when z=d. From Maxwell's equations, the electric field can be expressed for s polarization as:

[symbol]

(d)={u(z),0,0}exp(ikαy)|_{z=d} (3)
and for p polarization as:

$$( d ) = \{ 0 , u ( z ) , - \frac{α}{\tilde{ε} ( z )} v ( z ) \} exp ( ik α y ) {\vert}_{z = d} \qquad ( 4 )$$

where

$$k = \frac{2 π}{λ} ,$$

λ is a desired wavelength to be reflected, α=nₛ sin θₛ where “s” corresponds to the substrate in FIG. 8, and \tilde{ε}(z) is the permittivity of the layer as a function of z. As such:

|E(d)|²=|u(z)|² exp(2ikαy)|_{z=d} (5)
for s polarization, and

$${\vert E ( d ) \vert}^{2} = [ {\vert u ( z ) \vert}^{2} + {\vert \frac{α}{\sqrt{n}} v ( z ) \vert}^{2} ] exp ( 2 ik α y ) {\vert}_{z = d} \qquad ( 6 )$$

for p polarization.

It should be appreciated that variation of the electric field along the Z direction of the dielectric layer 4 can be estimated by calculation of the unknown parameters u(z) and v(z), where it can be shown that:

$${( \begin{matrix}u \\ v\end{matrix} )}_{z = d} = ( \begin{matrix}cos φ & ( i / q ) sin φ \\ iq sin φ & cos φ\end{matrix} ) {( \begin{matrix}u \\ v\end{matrix} )}_{z = 0 , substrate} \qquad ( 7 )$$

where ‘i’ is the square root of −1. Using the boundary conditions u|_{z=0}=1, v|_{z=0}=qₛ, and the following relations:

qₛ=nₛ cos θₛ for s-polarization (8)

qₛ=n s/cos θₛ for p-polarization (9)

q=n cos θ_{F}for s-polarization (10)

q=n/cos θ_{F} for p-polarization (11)

φ=k·n·d cos(θ_{F}) (12)
u(z) and v(z) can be expressed as:

$$\begin{matrix}u ( z ) {\vert}_{z = d} = u {\vert}_{z = 0} cos φ + v {\vert}_{z = o} ( \frac{i}{q} sin φ ) \\ = cos φ + \frac{i . {q}_{s}}{s} sin φ\end{matrix} \qquad ( 13 )$$

and

v(z)|_{z=d}=iqu|_{z=0} sin φ+v|_{z=0} cos φ=iq sin φ+qₛ cos φ (14)

Therefore:

$$\begin{matrix}{\vert E ( d ) \vert}^{2} = [ {cos}^{2} φ + \frac{{{q}_{s}}^{2}}{{q}^{2}} {sin}^{2} φ ] {e}^{2 ik αγ} \\ = [ {cos}^{2} φ + \frac{{{n}_{s}}^{2}}{{n}^{2}} {sin}^{2} φ ] {e}^{2 ik αγ}\end{matrix} \qquad ( 15 )$$

for s polarization with φ=k·n·d cos (θ_{F}), and:

$$\begin{matrix}{\vert E ( d ) \vert}^{2} = [ {cos}^{2} φ + \frac{{{n}_{s}}^{2}}{{n}^{2}} {sin}^{2} φ + \frac{{α}^{2}}{n} ( {q}_{s}^{2} {cos}^{2} φ + {q}^{2} {sin}^{2} φ ) ] \\ = [ ( 1 + \frac{{α}^{2} {q}_{s}^{2}}{n} ) {cos}^{2} φ + ( \frac{{{n}_{s}}^{2}}{{n}^{2}} + \frac{{α}^{2} {q}^{2}}{n} ) {sin}^{2} φ ]\end{matrix} \qquad ( 16 )$$

for p polarization where:

$$α = {n}_{s} sin {θ}_{s} = n sin {θ}_{F} \qquad ( 17 )$$

$${q}_{s} = \frac{{n}_{s}}{cos {θ}_{s}} \qquad ( 18 )$$

$$and$$

$${q}_{s} = \frac{n}{cos {θ}_{F}} \qquad ( 19 )$$

Thus for a simple situation where θ_{F}=0 or normal incidence, φ=k·n·d, and α=0:

$${\vert E ( d ) \vert}^{2} for s - polarization = {\vert E ( d ) \vert}^{2} for p - polarization = [ {cos}^{2} φ + \frac{{{n}_{s}}^{2}}{{n}^{2}} {sin}^{2} φ ] \qquad ( 20 )$$

$$= [ {cos}^{2} ( k \cdot n \cdot d ) + \frac{{{n}_{s}}^{2}}{{n}^{2}} {sin}^{2} ( k \cdot n \cdot d ) ] \qquad ( 21 )$$

which allows for the thickness “d” to be solved for (i.e., the position or location within the dielectric layer where the electric field is zero). It should be appreciated that the thickness “d” can be the thickness of the dielectric layer 120 extending over the reflective core layer 110 that provides a zero or near zero electric field at the interface between the dielectric layer 120 and the metallic absorbing layer 130. It should also be appreciated that the thickness “d” can also be the thickness of the dielectric outer layer 140 extending over the metallic absorbing layer 130 that provides a zero or near zero electric field at the interface between the dielectric outer layer and the metallic absorbing layer 130, depending on the thickness “d” where the electric field is zero or near-zero.

The at least one metallic absorbing layer 130 can, in embodiments, have a thickness between 5 nm and 20 nm, such as between 8 nm and 20 nm, between 10 nm and 20 nm, between 12 nm and 20 nm, between 15 nm and 20 nm, between 18 nm and 20 nm, between 5 nm and 18 nm, between 8 nm and 18 nm, between 10 nm and 18 nm, between 12 nm and 18 nm, between 15 nm and 18 nm, between 5 nm and 15 nm, between 8 nm and 15 nm, between 10 nm and 15 nm, between 12 nm and 15 nm, between 5 nm and 12 nm, between 8 nm and 12 nm, between 10 nm and 12 nm, between 5 nm and 10 nm, between 8 nm and 10 nm, or between 5 nm and 8 nm. In embodiments, the metallic absorbing layer 130 can be made from at least a material selected from W, Cr, Ge, Ni, stainless steel, Pd, Ti, Si, V, TiN, Co, Mo, Nb, ferric oxide, or combinations thereof. In one or more embodiments, the metallic absorbing layer 130 is comprised of W. In embodiments, ALD is used to deposit the metallic absorbing layer 130 because ALD allows uniform deposition of materials at the thicknesses desired. Other deposition methods have difficulty depositing uniform layers at thicknesses of 20 nm and below.

The at least one dielectric outer layer 140 can, in embodiments, have a thickness greater than 0.1 quarter wave (QW) to less than or equal to 4.0 QW where the control wavelength is determined by the target wavelength at the peak reflectance in the visible wavelength, such as between 0.5 QW and 4.0 QW, between 1.0 QW and 4.0 QW, between 1.5 QW and 4.0 QW, between 2.0 QW and 4.0 QW, between 2.5 QW and 4.0 QW, between 3.0 QW and 4.0 QW, or between 3.5 QW and 4.0 QW. In embodiments, the at least one dielectric outer layer 140 can have a thickness from greater than 0.1 QW to less than 3.5 QW, such as from greater than 0.1 QW to less than 3.0 QW, from greater than 0.1 QW to less than 2.5 QW, from greater than 0.1 QW to less than 2.0 QW, from greater than 0.1 QW to less than 1.5 QW, from greater than 0.1 QW to less than 1.0 QW, or from greater than 0.1 QW to less than 0.5 QW. In some embodiments, the at least one dielectric outer layer 140 can have a thickness from 0.5 QW to 3.5 QW, such as from 1.0 QW to 3.0 QW, or from 1.5 QW to 2.5 QW. In embodiments, the target wavelength may be about 1050 nm. The outer dielectric layer can be made from a dielectric material with a refractive index greater than 1.6 such as ZnS and TiO₂, or combinations thereof. In embodiments, the outer layer may be deposited by CVD or ALD.

In embodiments, the dielectric outer layer 140 can have a thickness between 5 and 500 nm, such as between 50 nm and 500 nm, between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, or between 450 nm and 500 nm. In some embodiments, the at least one dielectric layer 120 can have a thickness between 5 nm and 450 nm, such as between 5 nm and 400 nm, between 5 nm and 350 nm, between 5 nm and 300 nm, between 5 nm and 250 nm, between 5 nm and 200 nm, between 5 nm and 150 nm, between 5 nm and 100 nm, or between 5 nm and 50 nm. In embodiments, the dielectric outer layer can have a thickness between 50 nm to 450 nm, such as between 100 nm to 400 nm, between 150 nm to 350 nm, or between 200 nm to 300 nm.

Embodiments of the multilayer thin film 100 described above have a hue shift of less than 30°, such as less than 25°, less than 20°, less than 15°, or less than 10° in the Lab color space when viewed at angles from 0° to 45°.

In one or more embodiments, the multilayer thin film 100 comprises a reflective core layer 110 made from Al, a dielectric layer 120 deposited by ALD or CVD and made from TiO₂ extending across the reflective core layer 110, a metallic absorbing layer 130 deposited by ALD and made from W extending across the dielectric layer 120, and a dielectric outer layer 140 deposited by ALD or CVD and made from TiO₂ extending across the metallic absorbing layer 130.

In one or more embodiments, the multilayer thin film 100 comprises a reflective core layer 110 made from Al, a dielectric layer 120 deposited by ALD or CVD and made from TiO₂ extending across the reflective core layer 110, a metallic absorbing layer 130 deposited by ALD and made from W extending across the dielectric layer 120, and a dielectric outer layer 140 deposited by ALD or CVD and made from ZnS extending across the metallic absorbing layer 130.

Referring again to FIG. 1B, a multilayer thin film 100 that reflects an omnidirectional high chroma structural color according to embodiments is shown. The multilayer thin film 100 includes a reflective core layer 110, a protective layer 150 encapsulating the reflective core layer 110, a dielectric layer 120 extending across at least a portion of the protective layer 150, a barrier layer 160 extending across the dielectric layer, a metallic absorbing layer 130 extending across the barrier layer 160, and a dielectric outer layer 140 extending across the at least one metallic absorbing layer 130. In embodiments, the “outer layer” has an outer free surface (i.e., an outer surface not in contact with an absorbing layer or another dielectric layer that is not part of a protective coating). It should be appreciated that in embodiments two dielectric layers 120, two metallic absorbing layers 130, and two dielectric outer layers 140 can be positioned on opposing sides of the reflective core layer 110 such that the reflective core layer 110 is a core layer is encapsulated by a protective layer 150 and sandwiched between a pair of dielectric layers 120, a pair of metallic absorbing layers 130, and a pair of dielectric outer layers 140. Such a multilayer thin film with a reflective core layer 110 encapsulated by a protective layer 150 and sandwiched between a pair of dielectric layers 120, a pair of metallic absorbing layers 130, and a pair of dielectric outer layers 140 can be referred to as a nine-layer multilayer thin film.

The reflective core layer 110 can, in embodiments, have a thickness between 50 nm and 500 nm, such as between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, between 450 nm and 500 nm, between 50 nm and 450 nm, such as between 100 nm and 450 nm, between 150 nm and 450 nm, between 200 nm and 450 nm, between 250 nm and 450 nm, between 300 nm and 450 nm, between 350 nm and 450 nm, between 400 nm and 450 nm, between 50 nm and 400 nm, such as between 100 nm and 400 nm, between 150 nm and 400 nm, between 200 nm and 400 nm, between 250 nm and 400 nm, between 300 nm and 400 nm, between 350 nm and 400 nm, between 50 nm and 350 nm, such as between 100 nm and 350 nm, between 150 nm and 350 nm, between 200 nm and 350 nm, between 250 nm and 350 nm, between 300 nm and 350 nm, between 50 nm and 300 nm, such as between 100 nm and 300 nm, between 150 nm and 300 nm, between 200 nm and 300 nm, between 250 nm and 300 nm, between 50 nm and 250 nm, such as between 100 nm and 250 nm, between 150 nm and 250 nm, between 200 nm and 250 nm, between 50 nm and 200 nm, such as between 100 nm and 200 nm, between 150 nm and 200 nm, between 50 nm and 150 nm, such as between 100 nm and 150 nm, or between 50 nm and 100 nm.

In embodiments, the reflective core layer 110 can be made from at least one of a “gray metallic” material, such as Al, Ag, Pt, Sn; at least one of a “colorful metallic” material, such as Au, Cu, brass, bronze, TiN, Cr, or a combination thereof.

The at least one protective layer 150 can, in embodiments, have a thickness between 2 nm and 70 nm, such as between 5 nm and 70 nm, between 10 nm and 70 nm, between 20 nm and 70 nm, between 30 nm and 70 nm, between 40 nm and 70 nm, between 50 nm and 70 nm, between 60 nm and 70 nm, between 2 nm and 60 nm, between 5 nm and 60 nm, between 10 nm and 60 nm, between 20 nm and 60 nm, between 30 nm and 60 nm, between 40 nm and 60 nm, between 50 nm and 60 nm, between 2 nm and 50 nm, between 5 nm and 50 nm, between 10 nm and 50 nm, between 20 nm and 50 nm, between 30 nm and 50 nm, between 40 nm and 50 nm, between 2 nm and 40 nm, between 5 nm and 40 nm, between 10 nm and 40 nm, between 20 nm and 40 nm, between 30 nm and 40 nm, between 2 nm and 30 nm, between 5 nm and 30 nm, between 10 nm and 30 nm, between 20 nm and 30 nm, between 2 nm and 20 nm, between 5 nm and 20 nm, between 10 nm and 20 nm, between 2 nm and 10 nm, between 5 nm and 10 nm, or between 2 nm and 5 nm. In embodiments, the protective layer can be made from SiO₂, SnO₂, Al₂O₃, or combinations thereof. In embodiments, the protective layer 150 may be deposited across the reflective core layer 110 by wet chemistry deposition techniques, such as sol-gel deposition techniques.

Without being bound by any particular theory, it is believed that the protective layer 150 is advantageous in embodiments where a dielectric layer 120 extends across the reflective core layer 110 because the process for depositing the dielectric layer 120 can damage the reflective core layer 110 such as by oxidizing or deforming the reflective core layer 110. The protective layer 150 shields the reflective core layer 110 from the damage caused by the highly basic/acidic conditions of, for example, wet chemical deposition. However, the addition of a protective layer 150 can alter the reflectance of the reflective core layer 110. Therefore, a thin protective layer 150 with the thicknesses as described above is desired, as thicker protective layers may have undesirable effects on the reflectance of the multilayer thin film. In embodiments, the change in reflectance caused by the protective layer 150 can be compensated for by adding a corresponding metallic absorbing layer 130 and an outer layer made from a dielectric material.

The at least one dielectric layer 120 can, according to embodiments, have a thickness between 10 and 150 nm, such as between 25 nm and 150 nm, between 50 nm and 150 nm, between 75 nm and 150 nm, between 100 nm and 150 nm, between 125 nm and 150 nm, between 10 and 125 nm, between 25 nm and 125 nm, between 50 nm and 125 nm, between 75 nm and 125 nm, between 100 nm and 125 nm, between 10 and 100 nm, between 25 nm and 100 nm, between 50 nm and 100 nm, between 75 nm and 100 nm, between 10 and 75 nm, between 25 nm and 75 nm, between 50 nm and 75 nm, between 10 and 50 nm, between 25 nm and 50 nm, or between 10 and 25 nm.

The at least one dielectric layer 120 is TiO₂ and can be deposited across the reflective core layer 110 by chemical vapor deposition (CVD), atomic layer deposition (ALD), or wet chemistry processes. As disclosed above, the TiO₂ dielectric layer is, in embodiments, amorphous-phase TiO₂.

In embodiments comprising at least one barrier layer 160, the at least one barrier layer 160 may be made from Al₂O₃, and SiO₂, for example, and has a thickness that is from 1 nm to 15 nm, such as from 1 nm to 12 nm, from 1 nm to 10 nm, from 1 nm to 8 nm, from 1 nm to 6 nm, from 1 nm to 4 nm, from 1 nm to 2 nm, from 2 nm to 15 nm, from 2 nm to 12 nm, from 2 nm to 10 nm, from 2 nm to 8 nm, from 2 nm to 6 nm, from 2 nm to 4 nm, from 4 nm to 15 nm, from 4 nm to 12 nm, from 4 nm to 10 nm, from 4 nm to 8 nm, from 4 nm to 6 nm, from 6 nm to 15 nm, from 6 nm to 12 nm, from 6 nm to 10 nm, from 6 nm to 8 nm, from 8 nm to 15 nm, from 8 nm to 12 nm, from 8 nm to 10 nm, from 10 nm to 15 nm, from 10 nm to 12 nm, or from 12 nm to 15 nm. The at least one barrier layer 160 is deposited by ALD according to one or more embodiments. In embodiments, the at least one barrier layer 160 is SiO₂ and is deposited by wet chemical processes. In embodiments, the at least one barrier layer 160 is Al₂O₃ and is deposited by CVD.

The at least one metallic absorbing layer 130 can, in embodiments, be positioned such that the electric field of a target wavelength to be reflected is zero or near-zero, as discussed above. In embodiments, the at least one metallic absorbing layer 130 has a thickness between 5 nm and 20 nm, such as between 8 nm and 20 nm, between 10 nm and 20 nm, between 12 nm and 20 nm, between 15 nm and 20 nm, between 18 nm and 20 nm, between 5 nm and 18 nm, between 8 nm and 18 nm, between 10 nm and 18 nm, between 12 nm and 18 nm, between 15 nm and 18 nm, between 5 nm and 15 nm, between 8 nm and 15 nm, between 10 nm and 15 nm, between 12 nm and 15 nm, between 5 nm and 12 nm, between 8 nm and 12 nm, between 10 nm and 12 nm, between 5 nm and 10 nm, between 8 nm and 10 nm, or between 5 nm and 8 nm. In embodiments, the metallic absorbing layer 130 can be made from at least a material selected from W, Cr, Ge, Ni, stainless steel, Pd, Ti, Si, V, TiN, Co, Mo, Nb, ferric oxide, or combinations thereof. In one or more embodiments, the metallic absorbing layer 130 is comprised of W. In embodiments, ALD is used to deposit the metallic absorbing layer 130 because ALD allows uniform deposition of materials at the thicknesses desired. Other deposition methods have difficulty depositing uniform layers at thicknesses of 20 nm and below.

The at least one dielectric outer layer 140 can, in embodiments, have a thickness greater than 0.1 quarter wave (QW) to less than or equal to 4.0 QW where the control wavelength is determined by the target wavelength at the peak reflectance in the visible wavelength, such as between 0.5 QW and 4.0 QW, between 1.0 QW and 4.0 QW, between 1.5 QW and 4.0 QW, between 2.0 QW and 4.0 QW, between 2.5 QW and 4.0 QW, between 3.0 QW and 4.0 QW, or between 3.5 QW and 4.0 QW. In embodiments, the at least one dielectric outer layer 140 can have a thickness from greater than 0.1 QW to less than 3.5 QW, such as from greater than 0.1 QW to less than 3.0 QW, from greater than 0.1 QW to less than 2.5 QW, from greater than 0.1 QW to less than 2.0 QW, from greater than 0.1 QW to less than 1.5 QW, from greater than 0.1 QW to less than 1.0 QW, or from greater than 0.1 QW to less than 0.5 QW. In some embodiments, the at least one dielectric outer layer 140 can have a thickness from 0.5 QW to 3.5 QW, such as from 1.0 QW to 3.0 QW, or from 1.5 QW to 2.5 QW. In embodiments, the target wavelength may be about 1050 nm. The outer dielectric layer can be made from a dielectric material with a refractive index greater than 1.6 such as ZnS and TiO₂, or combinations thereof. In embodiments, the outer layer may be deposited by CVD or ALD.

In embodiments, the dielectric outer layer 140 can have a thickness between 5 and 500 nm, such as between 50 nm and 500 nm, between 100 nm and 500 nm, between 150 nm and 500 nm, between 200 nm and 500 nm, between 250 nm and 500 nm, between 300 nm and 500 nm, between 350 nm and 500 nm, between 400 nm and 500 nm, or between 450 nm and 500 nm. In some embodiments, the at least one dielectric layer 120 can have a thickness between 5 nm and 450 nm, such as between 5 nm and 400 nm, between 5 nm and 350 nm, between 5 nm and 300 nm, between 5 nm and 250 nm, between 5 nm and 200 nm, between 5 nm and 150 nm, between 5 nm and 100 nm, or between 5 nm and 50 nm. In embodiments, the dielectric outer layer can have a thickness between 50 nm to 450 nm, such as between 100 nm to 400 nm, between 150 nm to 350 nm, or between 200 nm to 300 nm.

Embodiments of the multilayer thin film 100 described above have a hue shift of less than 30°, such as less than 25°, less than 20°, less than 15°, or less than 10° in the Lab color space when viewed at angles from 0° to 45°.

In one or more embodiments, the multilayer thin film 100 comprises a reflective core layer 110 made from Al, a protective layer 150 deposited by wet chemical processes and made from SiO₂ encapsulating the reflective core layer 110, a dielectric layer 120 deposited by CVD, ALD, or wet chemical processes and made from TiO₂ extending across at least a portion of the protective layer 150, a metallic absorbing layer 130 deposited by ALD and made from W extending across the dielectric layer 120, and a dielectric outer layer 140 deposited by CVD or ALD and made from TiO₂ extending across the metallic absorbing layer 130.

In one or more embodiments, the multilayer thin film 100 comprises a reflective core layer 110 made from Al, a protective layer 150 deposited by wet chemical processes and made from SiO₂ encapsulating the reflective core layer 110, a dielectric layer 120 deposited by CVD or ALD, or wet chemical processes and made from TiO₂ extending across at least a portion of the protective layer 150, a metallic absorbing layer 130 deposited by ALD and made from W extending across the dielectric layer 120, and a dielectric outer layer 140 deposited by CVD or ALD and made from ZnS extending across the metallic absorbing layer 130.

In one or more embodiments, the multilayer thin film 100 comprises a reflective core layer 110 made from Al, a protective layer 150 deposited by wet chemical processes and made from SiO₂ encapsulating the reflective core layer 110, a dielectric layer 120 deposited by CVD, ALD, or wet chemical processes and made from TiO₂ extending across at least a portion of the protective layer 150, a barrier layer 160 deposited by ALD and made from Al₂O₃ extending across the dielectric layer 120, a metallic absorbing layer 130 deposited by ALD and made from W extending across the barrier layer 160, and a dielectric outer layer 140 deposited by CVD or ALD and made from TiO₂ extending across the metallic absorbing layer 130.

In one or more embodiments, the multilayer thin film 100 comprises a reflective core layer 110 made from Al, a protective layer 150 deposited by wet chemical processes and made from SiO₂ encapsulating the reflective core layer 110, a dielectric layer 120 deposited by CVD, ALD, or wet chemical processes and made from TiO₂ extending across at least a portion of the protective layer 150, a barrier layer 160 deposited by ALD and made from Al₂O₃ extending across the dielectric layer 120, a metallic absorbing layer 130 deposited by ALD and made from W extending across the barrier layer 160, and a dielectric outer layer 140 deposited by CVD or ALD and made from ZnS extending across the metallic absorbing layer 130.

The multilayer thin films in embodiments disclosed herein can be used as pigments (e.g., paint pigments for a paint used to paint an object), or a continuous thin film applied to an object. When used as pigments, at least one of paint binders and fillers can be used and mixed with the pigments to provide a paint that displays an omnidirectional high chroma red structural color. In addition, other additives may be added to the multilayer thin film to aid the compatibility of multilayer thin film in the paint system. Exemplary compatibility-enhancing additives include silane surface treatments that coat the exterior of the multilayer thin film and improve the compatibility of multilayer thin film in the paint system. Such paint systems or films can be used on any article, including an automotive vehicle.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

### EXAMPLES

Embodiments will be further clarified by the following examples.

### Example 1

Five simulations were conducted using an amorphous-phase TiO₂ dielectric absorber layer having a refractive index from 2.2 to 2.3. The thickness of the TiO₂ dielectric absorber layer was varied in the simulations. Each of the simulations included an aluminum core, an amorphous-phase TiO₂ dielectric absorber layer deposited on the aluminum core, and a 10 nm thick tungsten absorber layer deposited on the amorphous-phase TiO₂.

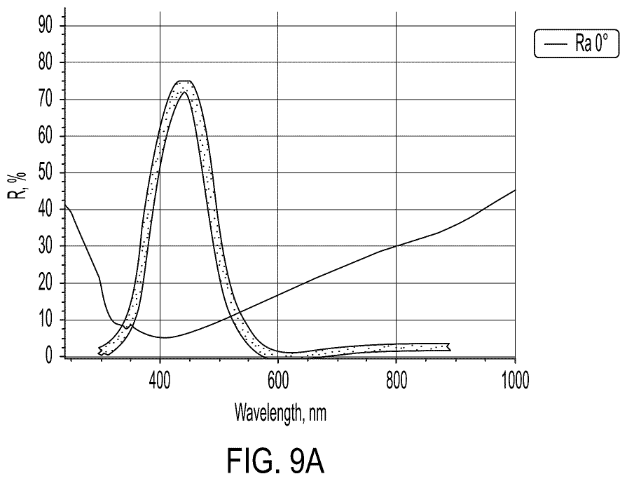

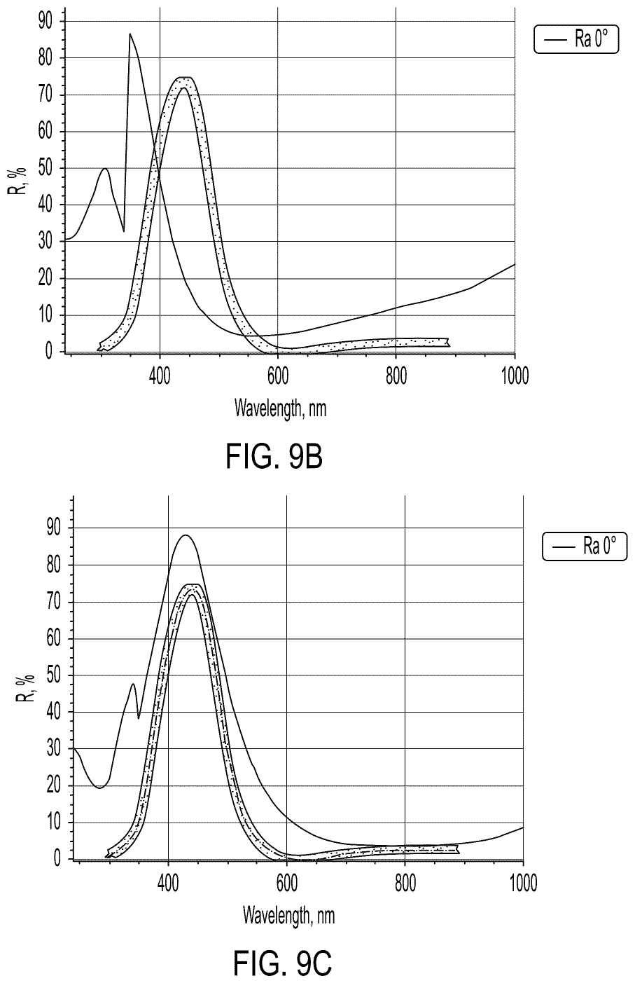

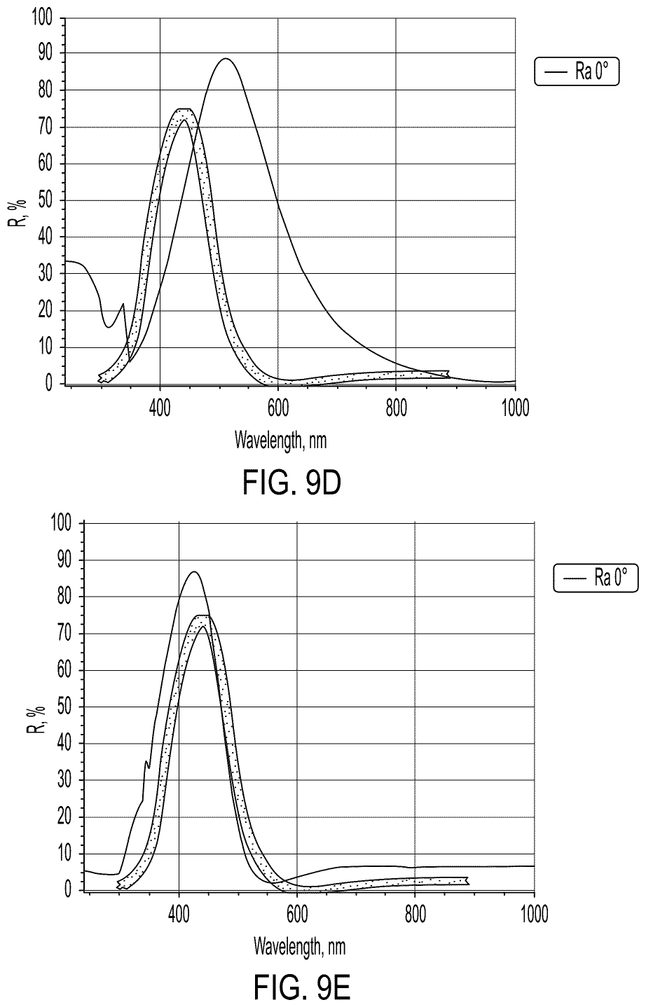

FIG. 9A depicts a reflection curve of a simulation where the amorphous-phase TiO₂ layer has a thickness of 30 nm. The target reflection curve is thicker with a single spike around a wavelength of 400 nm, and the simulated curve is lighter. As shown in FIG. 9A, the simulated reflection curve does not match the target reflection curve.

FIG. 9B depicts a reflection curve of a simulation where the amorphous-phase TiO₂ layer has a thickness of 50 nm. The target reflection curve is thicker with a single spike around a wavelength of 400 nm, and the simulated curve is lighter. As shown in FIG. 9B, the simulated reflection curve is close to, but does not match the target reflection curve.

FIG. 9C depicts a reflection curve of a simulation where the amorphous-phase TiO₂ layer has a thickness of 70 nm. The target reflection curve is thicker with a single spike around a wavelength of 400 nm, and the simulated curve is lighter. As shown in FIG. 9C, the simulated reflection curve closely matches the target reflection curve.

FIG. 9D depicts a reflection curve of a simulation where the amorphous-phase TiO₂ layer has a thickness of 90 nm. The target reflection curve is thicker with a single spike around a wavelength of 400 nm, and the simulated curve is lighter. As shown in FIG. 9D, the simulated reflection curve is broader than the target reflection curve.

FIG. 9E depicts a reflection curve of a simulation where the amorphous-phase TiO₂ layer has a thickness of 70 nm and an additional amorphous-phase TiO₂ layer having a thickness of 70 nm is deposited on the 10 nm thick tungsten absorber layer. The target reflection curve is thicker with a single spike around a wavelength of 400 nm, and the simulated curve is lighter. As shown in FIG. 9E, the simulated reflection curve closely matches the target reflection curve.

### Example 2

Six simulations were conducted using an amorphous-phase TiO₂ dielectric absorber layer having a refractive index from 1.8 to 2.0. The thickness of the TiO₂ dielectric absorber layer was varied in the simulations. Each of the simulations included an aluminum core, an amorphous-phase TiO₂ dielectric absorber layer deposited on the aluminum core, and a 10 nm thick tungsten absorber layer deposited on the amorphous-phase TiO₂.

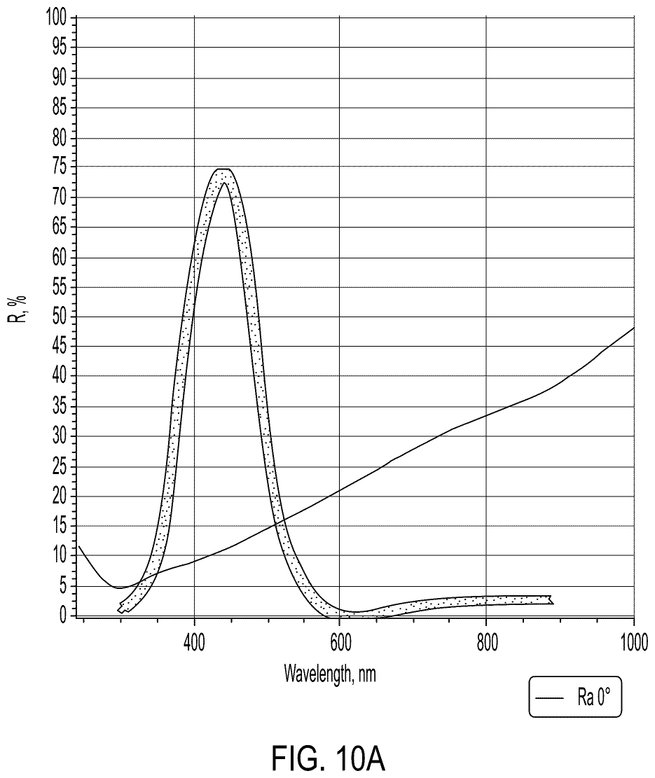

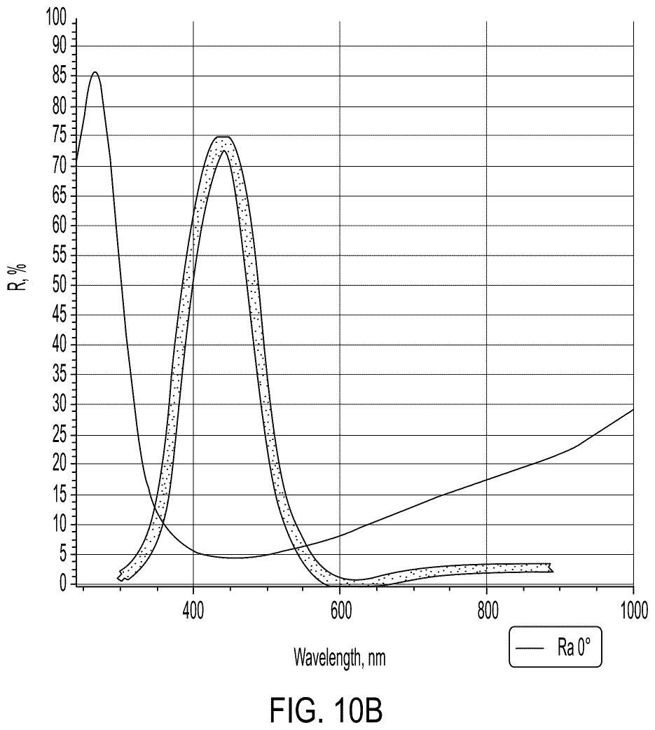

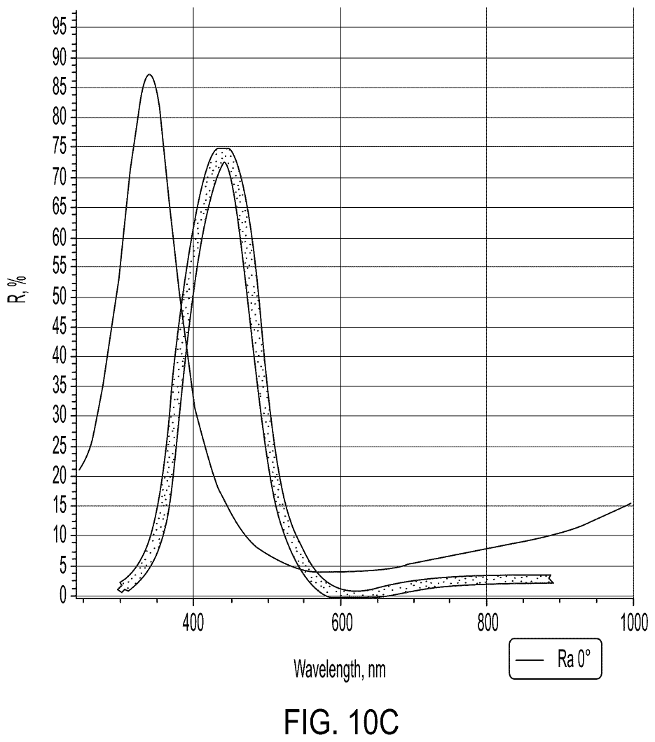

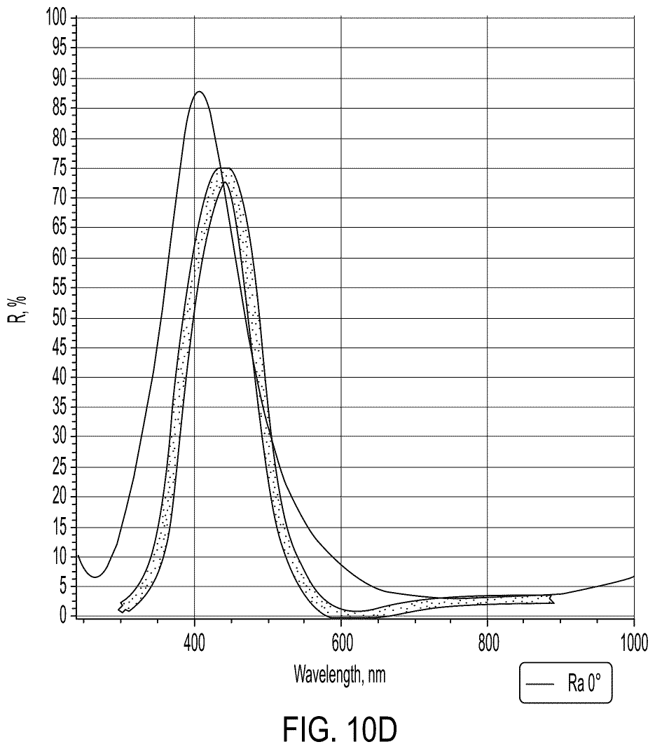

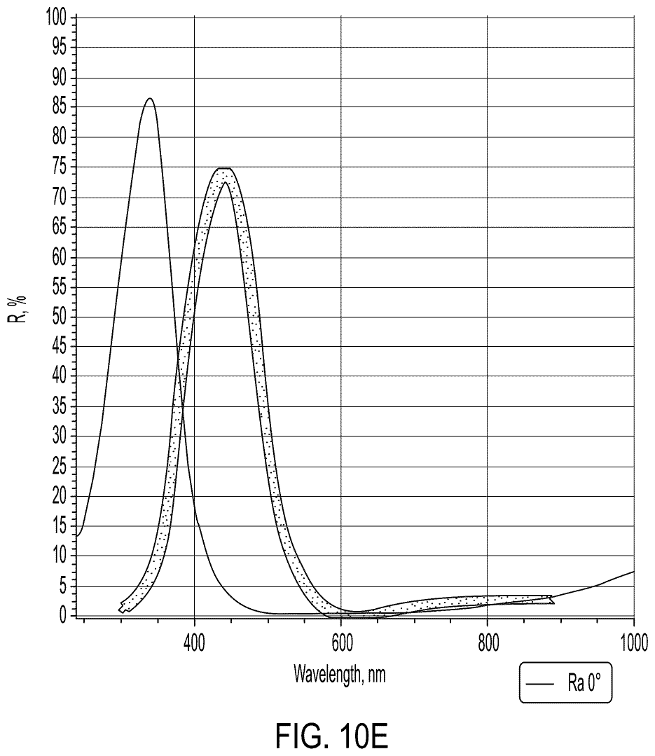

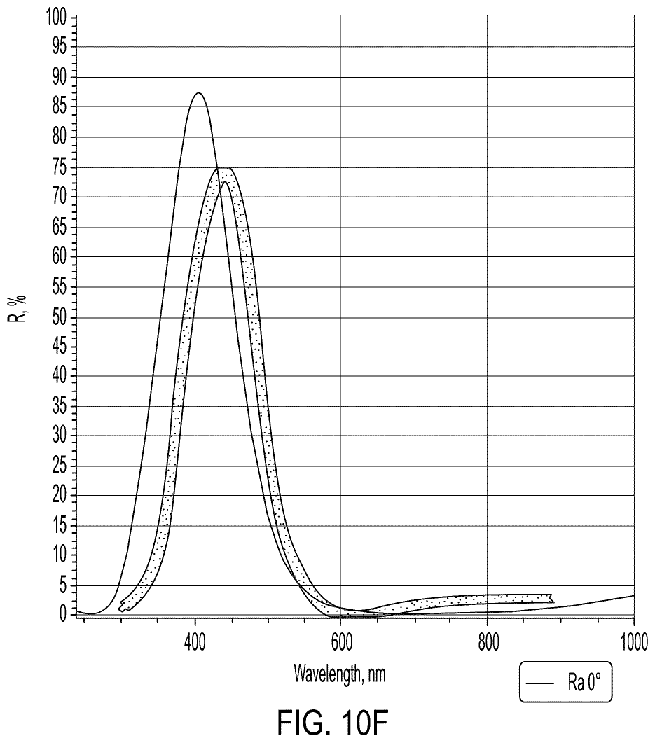

FIG. 10A depicts a reflection curve of a simulation where the amorphous-phase TiO₂ layer has a thickness of 30 nm. The target reflection curve is thicker with a single spike around a wavelength of 400 nm, and the simulated curve is lighter. As shown in FIG. 10A, the simulated reflection curve does not match the target reflection curve.

FIG. 10B depicts a reflection curve of a simulation where the amorphous-phase TiO₂ layer has a thickness of 50 nm. The target reflection curve is thicker with a single spike around a wavelength of 400 nm, and the simulated curve is lighter. As shown in FIG. 10B, the simulated reflection curve does not match the target reflection curve.

FIG. 10C depicts a reflection curve of a simulation where the amorphous-phase TiO₂ layer has a thickness of 70 nm. The target reflection curve is thicker with a single spike around a wavelength of 400 nm, and the simulated curve is lighter. As shown in FIG. 10C, the simulated reflection curve is close to, but does not match the target reflection curve.

FIG. 10D depicts a reflection curve of a simulation where the amorphous-phase TiO₂ layer has a thickness of 90 nm. The target reflection curve is thicker with a single spike around a wavelength of 400 nm, and the simulated curve is lighter. As shown in FIG. 10D, the simulated reflection curve matches the target reflection curve.

FIG. 10E depicts a reflection curve of a simulation where the amorphous-phase TiO₂ layer has a thickness of 70 nm and an additional amorphous-phase TiO₂ layer having a thickness of 70 nm is deposited on the 10 nm thick tungsten absorber layer. The target reflection curve is thicker with a single spike around a wavelength of 400 nm, and the simulated curve is lighter. As shown in FIG. 10E, the simulated reflection curve is close to, but does not match the target reflection curve.

FIG. 10F depicts a reflection curve of a simulation where the amorphous-phase TiO₂ layer has a thickness of 90 nm and an additional amorphous-phase TiO₂ layer having a thickness of 90 nm is deposited on the 10 nm thick tungsten absorber layer. The target reflection curve is thicker with a single spike around a wavelength of 400 nm, and the simulated curve is lighter. As shown in FIG. 10F, the simulated reflection curve closely matches the target reflection curve.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A multilayer thin film that reflects an omnidirectional structural color comprising:
a reflective core layer;
an amorphous-phase TiO₂ dielectric layer extending across the reflective core layer;
a metallic absorbing layer extending across the amorphous-phase TiO₂ dielectric layer; and
a dielectric outer layer extending across the metallic absorbing layer,
wherein the multilayer thin film reflects a single narrow band of visible light when exposed to broadband electromagnetic radiation, the single narrow band of visible light comprising:
a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

2. The multilayer thin film of claim 1, wherein the reflective core layer is formed from Al, Ag, Pt, Sn, Au, Cu, brass, bronze, TiN, Cr, or combinations thereof.

3. The multilayer thin film of claim 1, wherein the reflective core layer has a thickness between 50 nm and 500 nm.

4. The multilayer thin film of claim 1, wherein the amorphous-phase TiO₂ dielectric layer has a thickness between 10 nm and 150 nm.

5. The multilayer thin film of claim 1, wherein the metallic absorbing layer is formed from W, Cr, Ge, Ni, stainless steel, Pd, Ti, Si, V, TiN, Co, Mo, Nb, ferric oxide, or combinations thereof.

6. The multilayer thin film of claim 1, wherein the metallic absorbing layer has a thickness between 5 nm and 20 nm.

7. The multilayer thin film of claim 1, wherein the dielectric outer layer is formed from ZnS, TiO₂, and combinations thereof.

8. The multilayer thin film of claim 1, wherein the dielectric outer layer has a thickness greater than 0.1 quarter wave (QW) to less than or equal to 4.0 QW where a control wavelength is determined by a target wavelength at a peak reflectance in a visible wavelength.

9. The multilayer thin film of claim 1, wherein the dielectric outer layer has a thickness between 5 nm and 500 nm.

10. The multilayer thin film of claim 1, wherein
the reflective core layer is formed from Al,
the metallic absorbing layer is formed from W, and
the dielectric outer layer is formed from ZnS or TiO₂.

11. A multilayer thin film that reflects an omnidirectional structural color comprising:
a reflective core layer;
a protective layer encapsulating the reflective core layer;
an amorphous-phase TiO₂ dielectric layer extending across at least a portion of the protective layer;
a barrier layer extending across the amorphous-phase TiO₂ dielectric layer;
a metallic absorbing layer extending across the barrier layer; and
a dielectric outer layer extending across the metallic absorbing layer, wherein
the multilayer thin film reflects a single narrow band of visible light when exposed to broadband electromagnetic radiation, the single narrow band of visible light comprising:
a color shift of the single narrow band of visible light is less than 30° measured in Lab color space when the multilayer thin film is exposed to broadband electromagnetic radiation and viewed from angles between 0° and 45° relative to a direction normal to an outer surface of the multilayer thin film.

12. The multilayer thin film of claim 11, wherein the reflective core layer is formed from Al, Ag, Pt, Sn, Au, Cu, brass, bronze, TiN, Cr, or combinations thereof.

13. The multilayer thin film of claim 11, wherein the reflective core layer has a thickness between 50 nm and 500 nm.

14. The multilayer thin film of claim 11, wherein the protective layer is formed from SiO₂, SnO₂, Al₂O₃, or combinations thereof.

15. The multilayer thin film of claim 11, wherein the protective layer has a thickness between 2 nm and 70 nm.

16. The multilayer thin film of claim 11, wherein the amorphous-phase TiO₂ dielectric layer has a thickness between 10 nm and 150 nm.

17. The multilayer thin film of claim 11, wherein the metallic absorbing layer is formed from W, Cr, Ge, Ni, stainless steel, Pd, Ti, Si, V, TiN, Co, Mo, Nb, ferric oxide, amorphous silicon, or combinations thereof.

18. The multilayer thin film of claim 11, wherein the metallic absorbing layer has a thickness from 5 nm to 20 nm.

19. The multilayer thin film of claim 11, wherein the dielectric outer layer is formed from ZnS, TiO₂, and combinations thereof.

20. The multilayer thin film of claim 11, wherein the dielectric outer layer has a thickness greater than 0.1 quarter wave (QW) to less than or equal to 4.0 QW where a control wavelength is determined by a target wavelength at a peak reflectance in a visible wavelength.

21. The multilayer thin film of claim 11, wherein the dielectric outer layer has a thickness between 5 nm and 500 nm.

22. The multilayer thin film of claim 11, wherein the barrier layer is formed from Al₂θ₃.

23. The multilayer thin film of claim 11, wherein the barrier layer has a thickness that is between 1 nm and 15 nm.

24. The multilayer thin film of claim 11, wherein
the reflective core layer is formed from Al,
the protective layer is formed from SiO₂,
the metallic absorbing layer is formed from W,
the barrier layer is made formed from Al₂O₃, and
the dielectric outer layer is formed ZnS or TiO₂.

25. A method for forming the multilayer thin film of claim 1, the method comprising:
depositing the amorphous-phase TiO₂ dielectric layer onto the reflective core layer by CVD or ALD;
depositing the metallic absorbing layer onto the amorphous-phase TiO₂ dielectric layer by ALD; and
depositing the dielectric outer layer onto the metallic absorbing layer by CVD or ALD.

26. A method for forming the multilayer thin film of claim 11, the method comprising:
depositing the protective layer onto the reflective core layer by wet chemical processes;
depositing the amorphous-phase TiO₂ dielectric layer onto the protective layer by CVD, ALD, or wet chemical processes;
depositing the barrier layer onto the amorphous-phase TiO₂ dielectric layer by ALD;
depositing the metallic absorbing layer onto the barrier layer by ALD; and
depositing the dielectric outer layer onto the metallic absorbing layer by CVD or ALD.

27. A paint system comprising:
a binder; and
a multilayer thin film of claim 1.

28. An automotive vehicle comprising the paint system of claim 27.

29. A paint system comprising:
a binder; and
a multilayer thin film of claim 11.

30. An automotive vehicle comprising the paint system of claim 29.
